(19) United States
(12) Patent Application Publication
(10) Pub. No.: US 2019/0107846 A1
(43) Pub. Date: Apr. 11, 2019

(54) DISTRIBUTED SYSTEM FOR MANAGEMENT AND CONTROL OF AERIAL VEHICLE AIR TRAFFIC

(71) Applicant: The Charles Stark Draper Laboratory, Inc., Cambridge, MA (US)

(72) Inventors: Nilay K. Roy, Newton Highlands, MA (US); Michael A. Ridge, Cambridge, MA (US); Scott E. Lennox, Arlington, MA (US); Rami Mangoubi, Newton, MA (US); Murali V. Chaparala, Newton, MA (US)

(21) Appl. No.: 16/153,241

(22) Filed: Oct. 5, 2018

Related U.S. Application Data
(60) Provisional application No. 62/568,962, filed on Oct. 6, 2017.

(51) Int. Cl. G05D 1/10; G06N 99/00; G08G 5/00; B64C 39/02; G05D 1/00; G08G 5/04

(52) U.S. Cl. CPC G05D 1/104; G06N 99/005; G08G 5/0043; B64C 2201/141; B64C 39/024; G05D 1/0088; G08G 5/04; G08G 5/0013

(57) ABSTRACT

A system for management and control of vehicles is disclosed. In one example, the system manages and controls air traffic of aerial vehicles such as unmanned aerial vehicles (UAVs). The vehicular system includes vehicles including sensors for gathering sensor data, and a distributed control system that controls and manages the vehicles using the sensor data.

### RELATED APPLICATIONS

This application claims the benefit under 35 USC 119(e) of U.S. Provisional Application No. 62/568,962, filed on Oct. 6, 2017, which is incorporated herein by reference in its entirety.

### BACKGROUND OF THE INVENTION

Groups of unmanned aerial vehicles (UAVs) have been proposed for different tasks. These include search and rescue, reconnaissance, surveying, detection/monitoring, exploration and mapping, hazardous material handling, for example. The coordinated operation of a group of UAVs facilitates the execution of certain missions more effectively and faster than might be accomplished by a single device. The UAVs on these missions could exchange sensor information, collaboratively identify targets, and move-deliver objects.

Coordination of individual UAVs and the larger group presents challenges. Different algorithms have been suggested. Complete algorithms require time and are exponential. Sampling-based algorithms can scale more easily. And the decision architectures can be centralized or decentralized.

Communication and networking are other considerations. Current systems have a single unshared link between each UAV and a control system. Such an approach will not scale, however. Therefore, inter UAV communications in different topologies are typically discussed. Another important consideration is how these topologies are affected as the UAVs move with respect to each other.

### SUMMARY OF THE INVENTION

A vehicular system that provides autonomous control and management of vehicles such as unmanned aerial vehicles (UAVs) is proposed. The system can control, possibly in stealth, hundreds or possibly thousands of UAVs maneuvering in groups and optimally use resources of the UAVs for solving a given problem (e.g., dealing with ground cover based on visibility and weather). The system can further enable operation of the UAVs in differential GPS and GPS-denied environments, in examples.

The proposed system is especially applicable to different missions, where there is a need for groups of UAVs in the missions to learn from and share tactical information with each other. The UAVs might be included in groups deployed in a battlefield or natural disaster environment, in one example.

According to concepts of the invention, the UAVs learn as they encounter different aspects from different missions and locations. For this purpose, the UAVs typically rely on parallel learning to impart new knowledge to all UAVs. Parallel learning enables precision release, precision assembly and parallel execution of varying tasks. Trajectory tracking and projections with prediction accuracy is automated with the learning. Payload (nano to bulky) determination can be based on the learning. Navigation and evasive maneuvers are controlled and are flexible as the learning is reinforced. The system also supports “locust mode” for ultra-high density formations of UAVs in the groups.

The proposed system supports many learning and active adaptation capabilities. These include: sparse and dense swarming with active measure and dampening of wind gusts; low altitude high speed sustained operation and precision maneuvers; large cover sensor network with real-time feature identification and learning; simultaneous cooperation and feedback in a manned and unmanned UAV scenarios, with the ratio of manned to unmanned vehicles ranging from 1:1000 to 1:1000000 and even higher in a given airspace subject to saturation points; enabling multiple network control protocols and ground stations or other manned aerial vehicles to redundantly control the UAVs; enabling multiple sensors to be deployed by specialized UAVs; and multiple testbeds (possibly) in the field and lab to validate extensive simulations of sensor signals and real-time simulations of UAVs, with control and AI (artificial intelligence) logic enabled for learning validation and testing over different terrain, weather conditions and related scenarios.

In one implementation, at least one UAV within each group is designated as a group local controller. The group local controller UAV controls the other UAVs in each group for multiple and varied objectives.

The groups might be swarms of UAVs. A swarm is a group of UAVs driven by artificial intelligence. The swarms can include different numbers of UAVs having different capabilities.

Typically, the group has more than 100 UAVs, and possibly 1000 or more. In this way, different specialized groups or swarms can be controlled and deployed in parallel to carry out different mission objectives, with minimal payload and maximum reusability. This not possible with human controllers.

A distributed control system of the vehicular system plans, manages, and controls the groups. In examples, the control system executes distribution of mission tasks and enables swarms for repair and service of other airborne aircraft. The control system can also initially deploy one or more “scout” groups having a minimum number (e.g. less than 10) UAVs that pre-learn terrain information and weather information of a destination. The control system can then apply the learning from the scout groups to much larger groups/swarms to efficiently achieve task parallelism, in one example.

The proposed system is applicable to vehicles such as automobiles, and to manned/unmanned aerial vehicles, in examples. In the case of the UAVs, the system can support UAVs ranging in size from small scale (micro) UAVs weighing a few kilograms or less, to much larger “mega” UAVs weighing hundreds or possibly thousands of kilograms. Generally, larger and higher speed UAVs have higher Reynolds numbers, which indicates the transition to turbulence from inviscid laminar flow.

In general, according to one aspect, the invention features a vehicular system. The system includes a group of vehicles that communicate directly with each other; and a distributed control system that controls and manages the group.

The vehicles are preferably unmanned aerial vehicles. And the groups will typically include greater than 100 vehicles, and possibly more than 1000 vehicles.

One or more of the vehicles of the group can be designated as a group local controller.

Preferably, the vehicles employ autonomous learning to form the group. The distributed control system includes a training system and a controller. The distributed control system sends initial models with background simulation data to each vehicle, the initial models providing each of the vehicles with autonomous control and group formation capabilities. Further, the distributed control system would specify destinations and time to reach those destinations for the group but the group determines self-avoiding trajectories to reach the destinations.

Each of the vehicles includes sensors for gathering data. The data from the sensors is processed on the vehicles using sensor fusion and PCA decomposition. This data from the sensors might be used to determine position and timing characteristics for the group for a detected wind pattern based on the sensors.

In general, according to another aspect, the invention features a vehicular control method. The method includes a group of vehicles communicating directly with each other, and a distributed control system of the group controlling and managing the group.

The above and other features of the invention, including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic diagram of an exemplary autonomous vehicular system for control and management of autonomous vehicles, constructed according to principles of the invention, where the autonomous vehicular system includes vehicles such as unmanned aerial vehicles (UAVs) in groups, and includes a distributed control system for controlling and managing the groups;

FIG. 2A is a block diagram showing various subsystems of the UAVs, according to one embodiment of the UAVs;

FIG. 2B is a block diagram showing more detail for a processing subsystem of the UAV in FIG. 2A;

FIG. 3A is a block diagram showing various subsystems of the UAVs, according to another embodiment of the UAVs, where a mobile user device attaches to the processing subsystem via a USB interface;

FIG. 3B is a block diagram showing more detail for the mobile user device attached to the UAV in FIG. 3A;

FIG. 4 and FIG. 5 are block diagrams that illustrate different operational models for artificial intelligence (AI) applications executing on the UAVs, where the illustrated models combine (“fuse”) sensor data from sensors of the UAV in different ways;

FIG. 6 shows different flight-related control loops executed by the processing subsystem of the UAV;

FIG. 7 is a sequence diagram that visually depicts interactions between the UAVs, a High Performance Computer Cluster (HPC) of the distributed system, and components of the distributed control system;

FIG. 8 is a block diagram showing more detail for a system controller within the distributed control system;

FIG. 9A-9D show different missions of UAVs, where the UAVs in each mission are formed into cooperative swarms of the UAVs by the distributed control system;

FIG. 10 is a schematic of sonar, radar and video capabilities of a typical UAV;

FIG. 11A-11D show different networks of UAVs, where the UAVs form the networks from data connections that the UAVs dynamically create between each other;

FIG. 12A shows two logarithmic scale plots that display an estimated number of humans required to control an individual swarm of UAVs, as a function of the number of UAVs in the swarm, where: a first plot shows the result when the swarms are not controlled with the vehicular system; and a second plot shows the result when the learning and active adaptation and control provided by the vehicular system are employed; and

FIG. 12B shows two logarithmic scale plots that display an estimated number of humans required to control multiple swarms of UAVs in parallel, as a function of the number of swarms of the UAVs, where: a first plot shows the result when the swarms are not controlled with the vehicular system; and a second plot shows the result when the learning and active adaptation and control provided by the vehicular system are employed.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

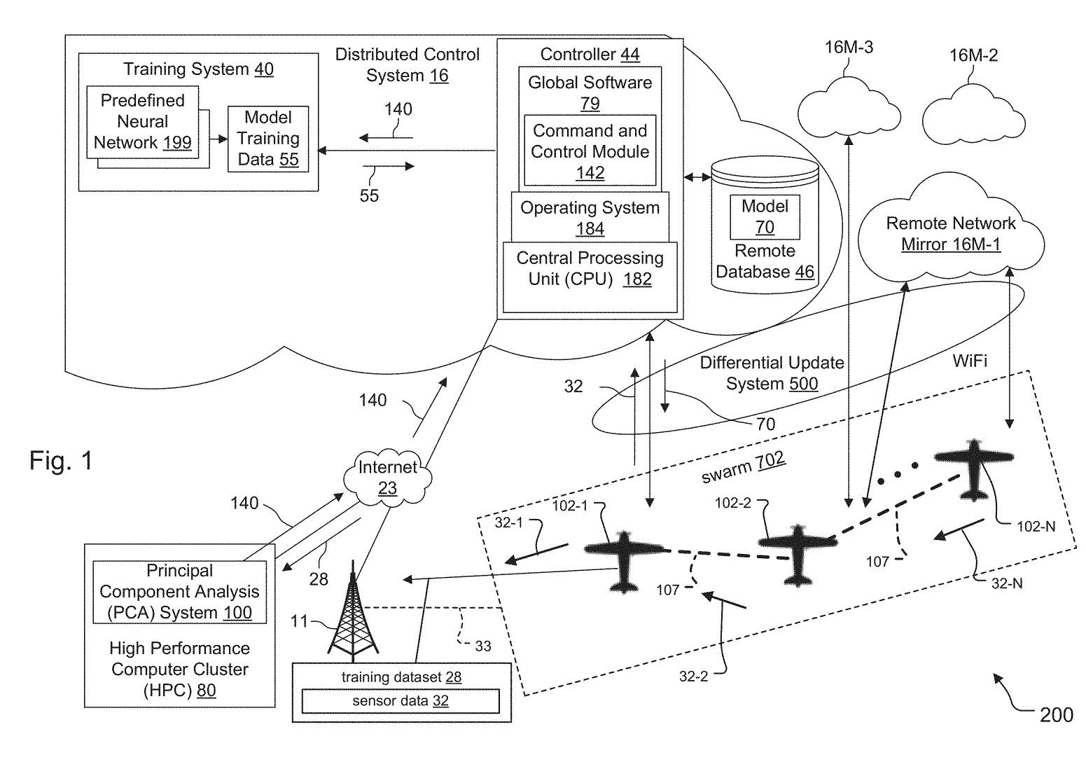

FIG. 1 is a schematic diagram of an exemplary autonomous vehicular system 200 for control and management of vehicles such as UAVs 102-1 . . . 102-N. The system 200 includes a group of the vehicles 102-1 . . . 102-N that communicate directly with each other, and a distributed control system that controls and manages the group.

The distributed control system 16 has various components and connects to both the internet 23 and the differential update system 500. These components include a training system 40, a controller 44, and a remote database 46.

The controller 44 operates as a system controller of the distributed control system 16 and also provides the connection to the internet 23, which provides connections to other remote network mirrors 16M. In the illustrated example, the distributed control system 16 is a cloud-based.

The training system 40 includes one or more predefined neural networks 199 and generates model training data 55. Each of the predefined neural networks 199 typically correspond to different neural network types.

The controller 44 is preferably a cloud-based distributed computing system with one more servers, each server including one or more central processing units (CPUs) 182, typically an operating system 184, and global software 79. In the illustrated example, a command and control module 142 of the global software 79 is shown. The controller 44, via its command and control module 142, creates neural network models 70 for deployment on the UAVs 102.

Three remote network mirrors 16M-1, 16M2, and 16M3 are shown. The remote network mirrors 16M, as their name suggests, are parallel distributed control systems, each with the same components and operation of the distributed control system 16. The remote network mirrors 16M provide alternate control nodes for the UAVs or other groups of UAVs in the event that the distributed control system 16 fails, is overutilized, or when the distributed control system 16 does not have a connection to the various UAVs 102. Typically, the remote network mirrors 16M-1, 16M2, and 16M3 and the distributed control system 16 are interconnected via a high speed communications internet backbone 23.

The capabilities of the system controller 44 can be mirrored to the other cloud based control nodes 16M for high availability and fault tolerance. Resources including computational, data and network resources can be added dynamically using edge cloud methods.

The differential update system 500 provides two-way data transfer between the UAVs and the distributed control system 16 for updating operation of the vehicles. The differential update system 500 is distributed across the system controller 44 and the UAVs 102. Specifically, the update system 500 has both a UAV portion at each of the UAVs, and a system controller 44 portion. One or more software or firmware modules at the UAVs and the controller 44 implement the respective portions of the differential update system 500.

In the illustrated example, the UAVs 102 communicate with other system components over radio frequency links including both WiFi and cellular network links. Preferably, the devices will utilize available networking protocols such as those based on UWB, IEEE 801.11/WiFi, IEEE 802.16/WiMax, IEEE 802.15.4/ZigBee, Bluetooth, NFC/RFID, Land Mobile Radio, and cellular 2G/3G/4G/5G to establish adequate data transfer rates while minimizing power consumption.

One of the UAVs is designated the local controller UAV 102-1, in one embodiment. That UAV might maintain a cellular network interface that connects to a tower 11 of a cellular network. The tower 11, in turn, connects to the internet 23. On the other hand, the other UAV's 102-2, 102-3, might communicate only with each other and the local control UAV 102-1, with only the local controller 102-1 communicating with the controller 44 via the differential update system 500.

The UAVs use the cellular network interface and possibly other wireless interfaces to connect the UAVs to the differential update system 500. These other wireless interfaces include WiFi, Bluetooth, and Iridium Short Burst Data (SBD), in examples.

The UAVs communicate with one another directly using wireless protocols such as WiFi and/or Bluetooth protocols via interUAV links 107. In the illustrated example, the UAVs 102 make WiFi and/or Bluetooth dynamic connections 107 that each of the UAVs create between one or more other UAVs in the group.

The UAVs 102 each include various sensors. Each sensor generates data, also known as sensor data 32. The UAVs utilized their sensor data 32 in the generation of local training sets 28, and send the training datasets 28 via the controller 42 to the HPC 80. The sensor data 32 can be in various forms, such as time-domain signals. The training datasets 28 then processed by a principal component analysis (PCA) system 100 of the HPC 80.

The UAVs also preprocess and refine sensor data and signals along with possibly sending “raw” sensor data and signal 32 via the differential update system 500 to the controller 44. Raw sensor data 32 is sensor data that the UAV and/or its local controller UAVs cannot preprocess/refine before sending to the system controller 44.

The UAVs 102 function in groups, also known as swarms. The swarms 702 of UAVs are typically defined during initialization/startup of the system 200, and dynamic swarms 702 can be created thereafter.

Typically, at least one UAV within each group/swarm is designated as a local control node, also known as a local controller UAV of the group.

The principal component analysis system (PCA) system 100 executing on the HPC 80 receives the training datasets 28 sent by the UAVs. Using content within the training datasets 28, the PCA can simulate content of training datasets 28 from future UAVs. The PCA system 100 determines principal components of the sensor data 32 for subsequent use by the training system 40. The principal components represent the sensor data 32.

Initial operation of the autonomous vehicular system 200 is as follows. The command and control module 142 of the controller 44 obtains an initial neural model 70 with background simulation data from the remote database 46. The models also include configuration parameters. The parameters define UAV membership in the swarms, and swarm attributes such as error handling, size and formation type. In this way, the controller 44 of the distributed control system 16 controls and manages sizes and formation of the groups.

The parameters also specify destinations and time to reach those destinations for the groups. The command and control module 142 then sends the model 70 to the UAVs by sending the models over the differential update system 500 to the UAVs 102.

At the UAVs, the initial neural network model 70 enables the UAVs to perform basic UAV autonomous control, form into groups/swarms, and to communicate with other UAVs within the group and components of the system 200. In addition, the initial neural network model 70 allows the UAVs to possibly process their sensor data. As a result, the initial models with the background simulation data sent to each vehicle provides each of the vehicles with autonomous control and group formation capabilities. Each UAV receives the model 70, and generates/updates a neural network from the model 70.

After initialization of the system and configuration of the UAVs, the system 200 generally operates as follows. The UAVs 102 identified to be in particular swarms 702 or groups deploy by assembling in a self-avoiding optimized path trajectory in a given time frame. The UAVs 102 determine self-avoiding trajectories to reach the destinations specified in the initial model 70.

The controller 44 can define, manage, and control many swarms/groups with each having possibly hundreds or more UAVs. Each group or swarm 702 can be highly trained for a particular task, and many swarms for different tasks can be deployed simultaneously/in parallel using the distributed control system 16 along with the other remote network mirrors 16M.

The local controller UAV(s) of each group operate as an intermediary between the controller 44 and the other UAVs within each group. As the number of UAVs within a group increases, the UAVs can dynamically designate more additional local controller UAVs within the group. Each of the local controller UAVs then typically controls a subset or subgroup of the UAVs in each group. Thus, each group of UAVs controls its division into subgroups of the vehicles.

As the groups of UAVs and number of UAVs within the groups increase over time, the use of these local controller UAVs promotes scalability. As a result, the cloud-based architecture of the distributed control system 16, combined with usage of the multiple local controller UAVs within the groups/swarms 702, avoids NP complete problems (polynomial space and time) that would otherwise occur if the controller 44 were to communicate with each of the UAVs directly, promotes scalability to hundreds or possibly thousands of UAVs, and possibly hundreds or thousands of groups of the UAVs.

In one mode of operation, the local controller UAV(s) in each group receive new models 70 from the controller 44. The local controller UAV(s) then send the models 70 to the other UAVs in the group, via the dynamic interUAV connections 107 to the other UAVs 102.

Once the UAVs 102 are deployed, learning also begins. This learning can occur at the level of the UAVs and at the controller 44. At the level of the UAVs, the UAVs 102 employ autonomous learning to form the groups. In this example, each UAV updates the neural network models/neural networks at the UAVs directly, instead of waiting for updated neural network models sent from the controller 44.

When training the UAVs in each group or swarm, the training includes processing the sensor data 32 such as terrain information, wind patterns, and other sensor inputs from various sensors of the UAV. Based on the training, in examples, the behavior of the UAVs in the swarm might change, and the membership of the UAVs within each swarm might change.

Learning at the level of the UAVs to form the groups generally operates as follows. Each UAV 102 or swarm 702 of UAVs may learn separately. Within each swarm 702, the local controller UAVs receives learning (e.g., new sensor data and signals 32) from the other UAVs in the swarm 702.

The learning at the level of the UAVs also involves using the sensor signals and response times to generate swarm patterns in real-time. The swarms are dictated by the pattern requirements and the trained neural networks used on each UAV. Thus, each swarm with a local controller UAV is autonomous in the pattern formation.

If required, the new sensor data 32 is often initially preprocessed and refined on the controller and then later refined on the UAV 102 before being sent to the controller 44 for further evaluation and instructions. Preprocessing generally involves normalizing the signals, sampling within Nyquist limits and discretizing/down sampling preferably without loss (lossless compression) and using trained neural networks 99, executing on the UAVs, to process it. If the deployment is a learning stage, however, then trained or fully trained neural networks may not be available. In such case, then the new sensor data and signals 32 are then possibly sent to the controller. In general, if trained neural networks are not available or if the sensor signal is from a new sensor or after recalibration of an existing sensor (via software updates), the raw sensor signal is often sent to the controller 99 until a trained neural networks is present on the UAV 102.

The trained neural networks on the UAVs process the input sensor signals to remove noise and if the signal is from one or more sensors perform sensor fusion. Preprocessing and refining the sensor signals ensure that the signal is corrected for noise, fused (if sensor fusion) and calibrated so that the concerned neural networks that use it for predictions, control feedback and interpretations have inputs in the expected format.

In some cases, QoS state functions values of the given UAV may result in the UAV not processing the signal (due to low available power for example or using its processing resources for more important control work as another example) and the raw signal will be sent directly to the controller, for processing and feedback to the local UAV.

In the remote database 46, the sensor characteristics and output calibration and response are stored. Then, during training, the raw sensor signals from the UAV sensors are collected (raw) and the controller 44 trains neural networks to process, discriminate and characterize the sensor signals. After sufficient training that includes sensor signal simulations, a basis set for a given sensor is created. Any sensor signal from this basis set can now be represented and a combination of the basis set. The trained neural network encapsulates this basis. Further the training also involves response to the signal input as an output if needed. This is required if the sensor signal (or signals) are used in guidance and navigation of the UAV. The sensor signals may be fused before inputting into the trained neural network or may be separately input.

The refinement of the sensor signal can be a separate step before input to the trained neural network. Once the trained network 99 is deployed to the UAV, new learning is autonomous on the UAV. The controller 44 can also detect new learning and push this out to the UAV's local controller for updates to the UAVs in the swarm or directly to the UAVs themselves. This feature and the ability to use the controller's simulation platform to fully characterize sensor signals, update the knowledge base and retrain neural networks with new learning autonomously is an important feature to allowing the swarm to evolve and address novel task and environments.

Then, at each UAV, the UAV 102 tries various neural network (NN) models, evolves the training autonomously and updates its own database in response. In more detail, the controller usually runs in cloud platform distributed control system 16 or a native high performance computing platform such as the high performance computer cluster 80. Since the controller 44 can be mirrored, one can use several large simulation platforms. As more compute or related resources are needed to simulate the sensor signals and training as well as storing the large knowledge base with data, PCA analysis and training or trained neural network models, the distributed nature of the platform allows this to be spanned across the simulation platform. Autonomous training involves now using various neural network architectures with the evolving knowledgebase and real and simulated sensor signals. Autonomous training works by running training jobs in parallel as the training parameters, network architectures and inputs are varied. Dueling generative adversarial nets (GANs) are also used to optimize the training and test and improve trained neural networks autonomously. Convergence criteria are also tested autonomously using GANs and other neural networks.

For each sensor, or high level metric, there is a different learning cycle. Learning cycles can run in parallel on each UAV or may be sequential on each UAV, depending on the available UAV resources. These resources include storage capacity, and processor speed and usage (for other control tasks) of the UAV. Sequential learning is a last resort and the UAV will have to repeat the formation and conditions. If parallel learning is not possible on each UAV 102, the sensor data is stored and transmitted to the controller 44 for learning to take place externally to the UAV 102. In this way, parallel learning is off-loaded from each UAV. The local controller UAVs then forwards the sensor data via the update system 500 to the system controller 44.

The controller 44 can also perform its own learning based upon the sensor data 32 sent from the UAVs/groups of UAVs over the update system 500.

The learning at the level of the controller 44 is generally as follows. The controller 44 has access to the large simulation platform implemented on the distributed control system 16 and/or the HPC 80. The simulation platform builds the models 70 and the neural networks from the models. The simulation platform then trains the neural networks to able to autonomously work on each UAV by training on the raw sensor data and signals 32. The same training on larger datasets from many UAVs and groups/swarms 702 of the UAVs can also be done on the controller 44. These simulations enable new learning at the controller 44, thus shortening learning time. Various types of neural networks are used including dueling GANs.

Based on the sensor type and maximum number of UAVs allowed, simulations executed on the controller 44 of various scenarios can be executed in parallel. These simulations are automated as the controller 44 goes through these scenarios using simulated sensor data and UAV positions. The controller 44 also trains the initial neural network models 70 for deployment on the UAVs.

Various other data are now built into the database 46 that learns from these training simulations executed on the controller 44 and/or HPC 80. This includes adding/refining new terrain data, adding/refining new swarm formation strategies, dynamically changing local controller UAVs, sensor calibration data and recalibration for accuracy desired as well as limits for UAV sensors, and malfunction and predictive failure data/parameters, and adding/refining new swarm formation strategies.

More detail for adding/refining new terrain data is as follows. Initially, a coarse terrain of the airspace is provided for the simulation. But as the training runs continue, better resolution simulation data is provided and the database is updated.

When deployed, the UAVs obtain images of other UAVs and terrain information as the sensor data using a high resolution camera as the sensor, in examples. When the UAVs are part of a swarm 702, the local controller UAVs also send the updated terrain information/image data to the remote database 46. This is all performed autonomously. If each UAV 102 has a better sensor for obtaining terrain data, such as a high-resolution camera or radar/LIDAR sensor, then each UAV can update its local database and send updates to the remote database 46.

The UAVs 102 also send their sensor data 32 to the HPC 80. The local controller UAVs receives sensor data 32 from the other UAVs in the group and also data training sets, and creates its own training dataset 28 that includes the sensor data from the UAVs in the group. In the illustrated example, the controller UAV 102-1 combines its own sensor data 32-1 with the sensor data 32-2 . . . 32-N of the other UAVs in the group, and includes the combined sensor data 32 in a single training dataset 28. The controller UAV 102-1 then sends the training dataset 28 to the PCA System 100 of the HPC 80 for analysis, via the tower 11 and the internet 23.

Preferably, at the HPC 80, the PCA system 100 determines principal components of the content of the training datasets 28. The principal components include feature vectors, basis vectors, and eigenvectors, in examples. The principal components also include a knowledge base with rules and axioms in conjunctive normal form from first-order logic rules. The basis set of these rules when satisfied by a neural network (the knowledge and inference system is neural network type agnostic) is also part of the feature vector and basis vector set.

The principal components that the PCA system 100 creates from the sensor data are also known as low level metrics signals 140. Here, the PCA system is typically looking for the basis of sets for fully reconstructing in a lossless manner the sensor data or sensor fusion input signals from the sensors deployed on the UAVs. The PCA system 100 then sends the low level metrics signals via the system controller 44 to the distributed control system 16 for further processing.

The training system 40 constructs its model training data 55 based upon a predefined neural network 199 and in response to the low level metrics signals 140 calculated and sent from the PCA system 100. Then, at the controller 44, the command and control module 142 generates an updated neural network model 70 for deployment on the UAVs from the model training data 55. The command and control module 142 then sends the model 70 for deployment on the UAVs 102 via the differential update system 500. The controller 44 also saves the model to the remote database 46.

The system 200 preferably employs a high degree of automation when performing many of its operations. The operations that include a high degree of automation include the learning of sensor signals at the UAVs, performing fusion of sensor data at the UAVs, the ability to create and direct swarms and groups, the updating the remote database 46 with new neural network models 70 and the new learning performed at the controller 44.

Via the controller 44, the human operator of the control system 16 can redefine the swarm parameters at any time during training or after deployment.

The HPC 80 executes simulations for training, testing, and validating the UAVs and the groups prior to deployment. For this purpose, in examples, the HPC 80 simulates the following: operation of the controller 44 and its command and control module 142 and its creation of models 70; and performing differential updates and other software updates to the UAVs 102.

Simulation scenarios also enable runs to emulate various jamming situations with respect to communications and AV control failures. This is important when building redundancy to communications and controls by having deployed alternate communication and mechanical circuits that can be activated.

Simulation scenarios also enable parallel runs far into the future of missions for each alternative providing a detailed analysis and strategy in parallel for the alternatives. This sort of simulation allows for: 1. Unanticipated conflict detection; 2. Compliance thresholds determination for new scenarios; 3. Analysis of separation volumes for various look-ahead times; and 4. Insertion and trial runs of conflict resolutions and verification testing. The entire process is automated after the air space parameters, geo-terrain and current conditions are fed into the scenario from the C&C database for “Compute instance 2 . . . n” (see below).

Guidelines of the Federal Aviation Administration (FAA), the National transportation Safety Board (NTSB), and other guidelines and safety parameters can be implemented to check and test the system 200. Using these guidelines, the system can be tested for compliance in real world deployment, and to evaluate a range of operation, gauge safety limits, identify accident scenarios, and to determine scalability and saturation levels for the number of UAVs that the system 200 controls, in examples. Worst case scenario runs and resultant effects can be performed and studied repeatedly.

For example, on the controller simulations of varies scenarios are tested. These involve virtual UAVs that have FAA, NTSB and other guidelines and parameters in a simulator. Input to all the UAVs come from a virtual environment (container) that runs the trained software. In this way the system is validated the virtual world. That is, the software structure and other implementations including learning and training are confirmed to operation within acceptable error margins.

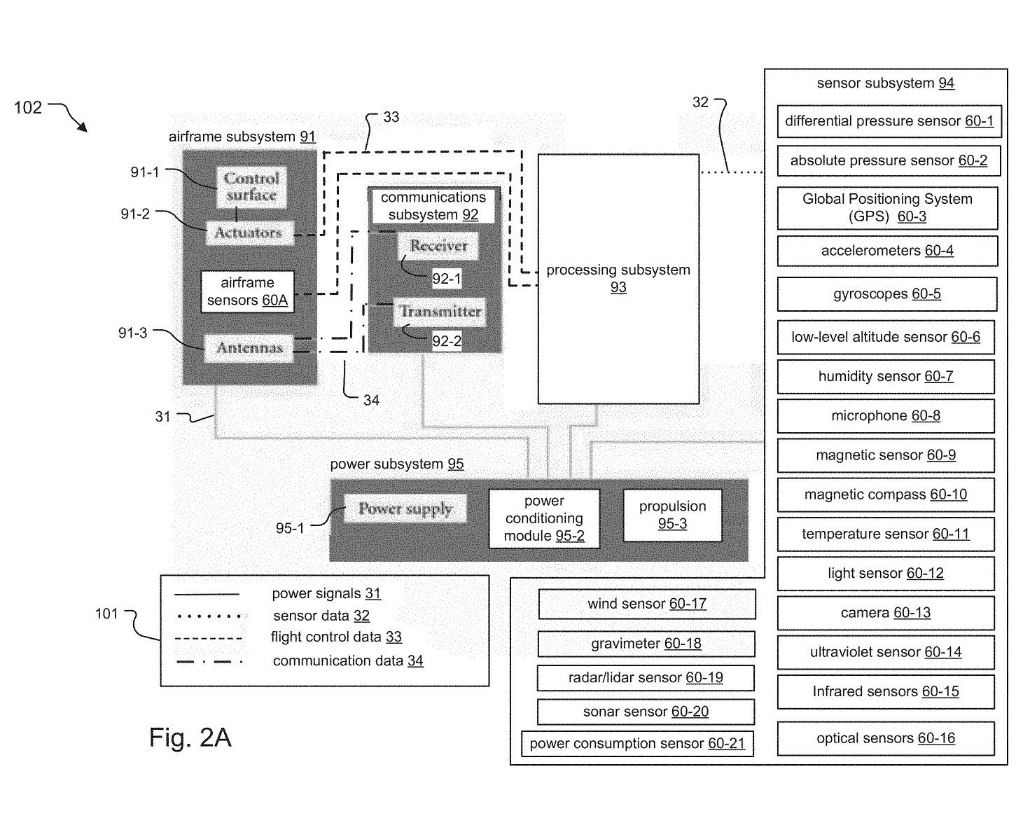

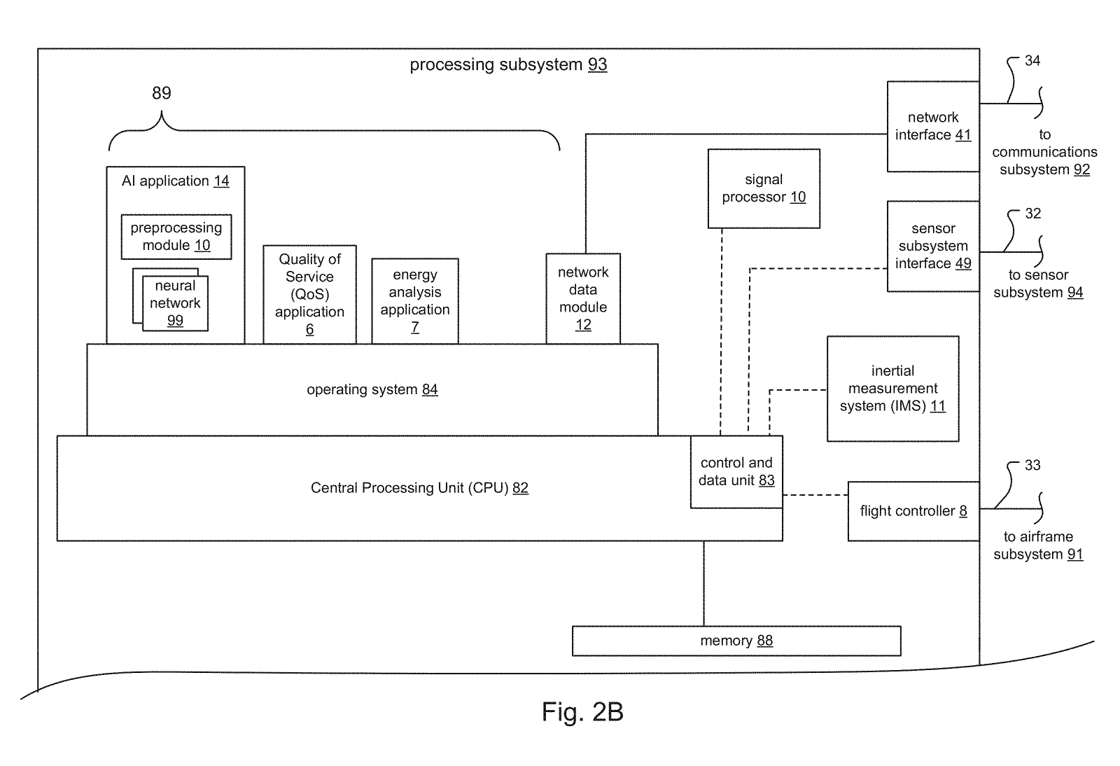

FIG. 2A shows various subsystems of the UAVs, according to an embodiment of the UAV. The subsystems include an airframe subsystem 91, a communications subsystem 92, a processing subsystem 93, a sensor subsystem 94, and a power subsystem 95.

The airframe subsystem 91 includes control surfaces 91-1. For an airplane/fixed wing-type UAV, these typically include ailerons, elevators, and the rudder. The ailerons are attached to the trailing edge of wings. The elevator is attached to the trailing edge of the horizontal stabilizer and controls pitch. The rudder is hinged to the trailing edge of the vertical stabilizer and control yaw. There are actuators 92-1 for these control surfaces. In addition, airframe sensors 60A such as wind sensors and pitot static tubes measure forward speed. Typically, antennas 91-3 are also incorporated into the airframe.

The communications subsystem includes one or more receivers 92-1 and one or more transmitters 92-2. The transmitters and receivers implement the protocols to enable UWB, IEEE 801.11/WiFi, IEEE 802.16/WiMax, IEEE 802.15.4/ZigBee, Bluetooth, NFC/RFID, Land Mobile Radio, and cellular 2G/3G/4G/5G communications both to the tower 11 and satellites and also between UAV in the inter-UAV links 107.

The power subsystem 95 includes a power supply 95-1, a power conditioning module 95-2, and a propulsion module 95-3. The power supply 95-1 supplies electrical power to the UAV; batteries and/or generators and/or fuel cells are different options. The power conditioning module 95-2 provides clean power at the voltages required by the various subsystems and modules of the UAV. The propulsion module 95-3 includes the jet turbine and/or motor-propellers that propel the UAV. In some cases, the motors turn the generator to generate the electrical power for the UAV. In other cases, the motors are electrically powered by the power supply 95-1.

In the illustrated example, the sensor subsystem 94 includes the following sensors: a differential pressure sensor 60-1 senses changes in atmospheric pressure; an absolute pressure sensor 60-2 senses absolute atmospheric pressure; a Global Positioning System (GPS) 60-3 detects location based on transmission from geostationary satellites; accelerometers 60-4 sense acceleration; gyroscopes 60-5 sense angular velocity; a low-level altitude sensor 60-6 detects height about the ground; a humidity sensor 60-7 senses humidity; a microphone 60-8 detects sound; a magnetic sensor 60-9 detector surrounding magnetic fields; a magnetic compass 60-10 detects orientation relative to the earth's gravitational field; a temperature sensor 60-11 detects ambient temperature; a light sensor 60-12 detect ambient light levels; one or more cameras 60-13 detect image data including image data of other UAVs and terrain during flight, such as a high-resolution camera; an ultraviolet camera 60-14; infrared camera 60-15; optical sensors 60-16; a wind sensor 60-17; a gravimeter 60-18 detects the strength of the earth's gravitational field; a radar/lidar sensor 60-19 detect range to objects; a sonar sensor 60-20 also detects range to objects; and a power consumption sensor 60-21 monitors power consumption and reports available power of the power supply 95-1 (e.g. battery). These sensors and detectors together generate the sensor data 32 that is sent to the processing subsystem. 93

FIG. 2B shows components of the processing system 93 in FIG. 2A. These components include local software 89, an operating system 84, a central processing unit 82, a signal processor 10, a network interface 41, a sensor subsystem interface 49, an inertial measurement system (IMS) 11, a flight controller 8, and memory 88.

The local software 89 executes upon the CPU 82 and includes various modules/applications. These include an artificial intelligence (AI) application 14, a quality of service (QoS) application 6, an energy analysis application 7, and a network data module 12. The operating system 84 loads instructions of the local software 89 into the memory 88, and schedules the local software 89 for execution upon the CPU 82.

The AI application 14 includes a preprocessing module 10 and one or more neural networks 99. The CPU 82 includes a control and data unit 83 that selects among the signal processor 10, the sensor subsystem interface 49, the IMS 11, and the flight controller 8.

The network data module 12 sends and receives communication data 34 via the network interface 41 to the communications system 92. The sensor subsystem interface 49 receives sensor data 32 from the sensor subsystem. The flight controller 8 receives the flight control data 34 from the airframe subsystem 91.

In one implementation, the QoS application 6 and the network data module 14 implement the UAV portion of the differential update system 500. The differential update system 500 determines an optimal data transmission rate, message/packet size, and preferred order for the information exchanged between the UAVs and the controller 44.

In more detail, the UAV portion of the update system 500 performs the following operations: samples the sensor data to determine the type and amount of the data; gauges available processor, memory and power resources of the UAV; determines available bandwidth of its one or more wireless connections to the controller 44 portion; and determines and a quality of service of the connections. Using information obtained from these operations, the UAV portion often prioritizes or cascades the transmission of the sensor data 32 based upon its type, based upon the group from which the data originates, reformats the messages that include the data into different sizes, and/or changes the transmission rate, and prioritizes information sent from one UAV to other UAVs, in examples. Such a differential update capability results in less bandwidth usage, power savings, and promotes scalability of the UAVs and the groups.

The processing subsystem 93 generally processes the sensor data 32 as follows. The control and data unit 83 of the CPU 82 provides the sensor data 32 via the operating system (OS) 84 to the AI application 14. The preprocessing module 10 preprocesses the data, and sends the data via the OS 84 through the CPU 82 for additional processing by the signal processor 10.

In general, the processing that the preprocessing module 10 performs on the sensor data 32 is as follows. All signals associated with the sensor data 32 are first renormalized. Based on the type of signal, the noise is then analyzed and removed. The signals are then sampled, and the sampling rate is checked against Nyquist frequency bounds to ensure alias-free sampling with lossless compression.

In many cases, the preprocessor 10 might combine peer-to-peer mode signals from multiple UAVs when the swarms have a small number of UAVs 102. This improves accuracy. If the swarm is large, the preprocessed signal is sent to the controller 44 for further use after preprocessing.

For a sensor fusion case, the preprocessing module 10, based on the sensor fusion method, preprocesses the sensor data 32. The preprocessing module 10 then sends the processed sensor data to the AI application 14, which in turn executes various fusion algorithms upon the processed sensor data. This preprocessing will vary dynamically in typically all cases, based upon: the signal quality at any given time; on the quality of the signals being fused at any given time, and the stage at where the fusion will occur (type of sensor fusion method used). The preprocessing is constantly fed back with the desired accuracy needed based on QoS of power, and sampling rate and sensor sensitivity parameters, in examples.

The sensor fusion strategy can be one or more several approaches depending on the number, type and sensitivity of the sensor and accuracy desired. Sensor fusion can be carried out by the trained neural network 99 when trained. On the other hand, sensor input signals can first filtered (using for example: Kalman, extended Kalman or unscented Kalman filters) then fused either directly or by the trained neural network 9. Sensor fusion can also be first done using a trained neural network with feedback of the output from one or more filters. Sensor signals are each processed by a neural network, fed into one or more filters in a feedback loop and then fused by a trained neural network. Sensor signals can also be decomposed into their PCA (basis) then fused directly or by a trained neural network. Any combination of the above can be used dynamically and autonomously depending on the sensors and whether training the networks or deployed

The AI application 14 performs learning tasks, as well as providing output to the controller 44 for various operations at the UAVs 102. These operations include: guidance and navigation, sensor calibration/recalibration, communication type and protocol to use, interface(s) to the local controller UAV 102 and system controller 44, swarm formation parameters and allowable errors and tolerances, in examples. In this way, each UAV has information that includes any limits placed upon its flight path/destinations from the simulations. As a result, when the UAVs encounter different environmental conditions such as wind patterns, temperatures, altitudes, and terrain changes as monitored from the sensor data 32, the UAVs can autonomously correct themselves and the swarms 702 to adjust to these changes. Such a feature is built into the learning/training using both real data and simulations.

The AI application 14 also predicts critical points during operation of the UAVs and groups. These critical points include collision trajectories, packing of UAV/distance closeness limits in a swarm, resource overallocation, power and storage limits reached, speed limits, and feedback to the local controller UAVs and the system controller 44 for malfunction or other failures, in examples. In this way, predictive failure for each UAV 102 is available for sensors, power supplies/power packs, or other components such as actuators and motors so that a UAV can be safely decommissioned when detected. The ability for the AI application 14 to execute the predictive failure is built into the learning/training, and can be executed before an actual failure happens.

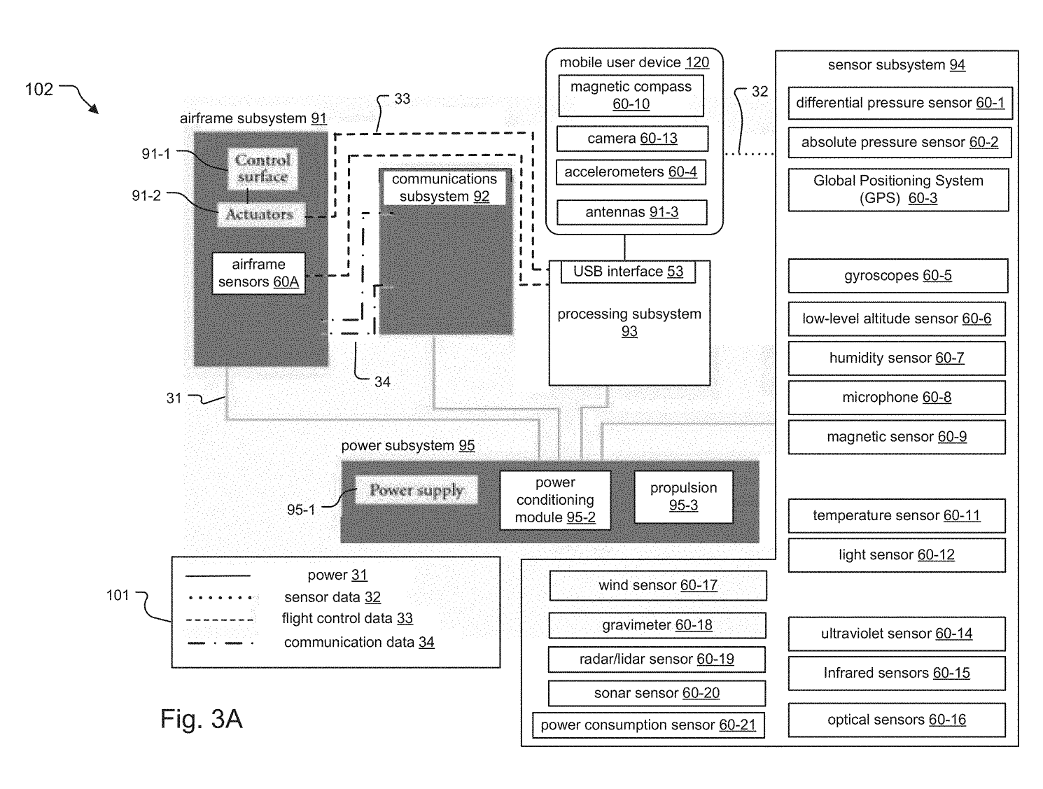

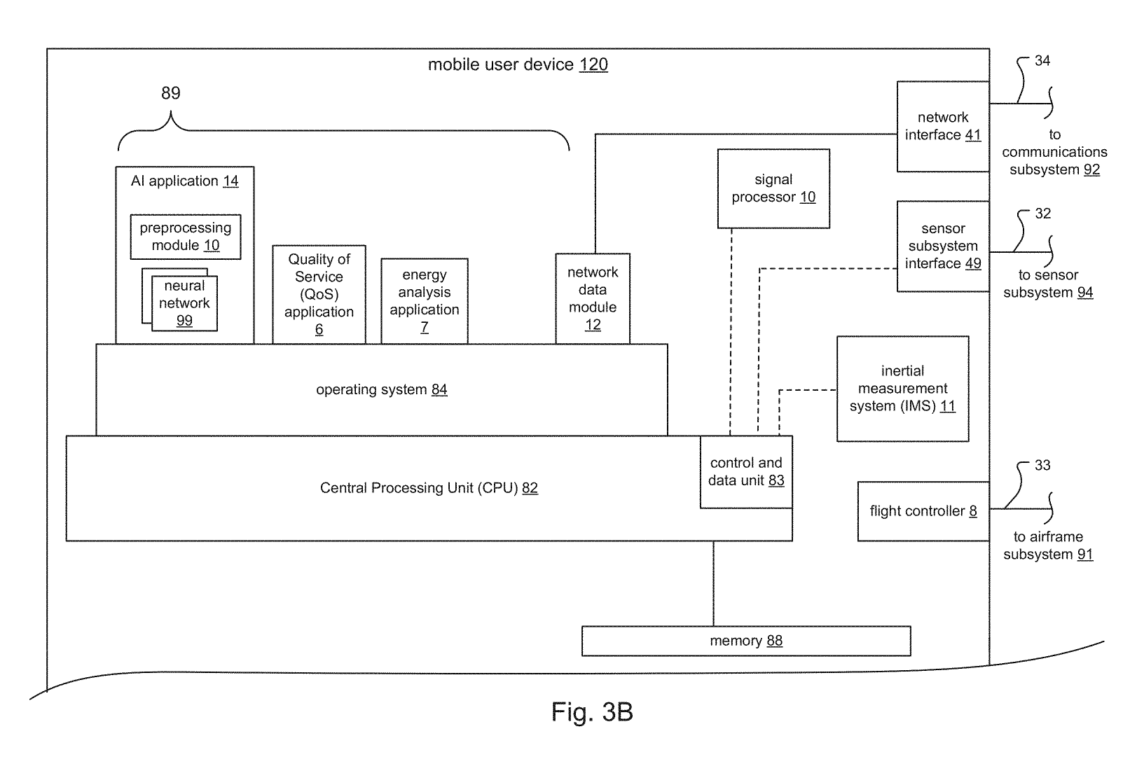

Other tasks performed by the AI application 14 include: creation of a local database/data storage at the processing subsystem 93 (UAV embodiment of FIG. 2A) or the mobile user device 120 (UAV embodiment of FIG. 3A); simulating various communications protocols using TCP/IP; running simulations of operations performed by the local software 89; simulating various sensors 60 of the sensor subsystem 94, and of the mobile user device 120 (UAV embodiment of FIG. 3A); simulating learning updates to the command and control interface 142; and executing instructions produced by parallel programming applications for testing the AI application 14.

In examples, the parallel programming applications (parallel programs) such as MPI and OpenMP can create or “branch out” several execution threads/instances of the parallel programs to explore different simulation scenarios. The instances of the parallel programs can then backtrack over the instances to select a best option, typically in a blocking fashion with respect to the other instances.

FIG. 3A shows various subsystems of the UAVs, according to another embodiment.

The UAV includes all subsystems as in FIG. 2A. In addition, a mobile user device 120 attaches to a data interface such as a Universal Serial Bus (USB) 53 interface. In examples, the mobile user device 120 might be a commodity handheld device (such as smartphone) that runs the Apple IOS or Android operating systems.

There are some differences between the subsystems as compared to the subsystems in FIG. 2A, however. In one example, the UAV 102 includes the same sensors 60 as in FIG. 2A, but some of the sensors are included in the mobile user device 120. Specifically, the mobile user device 120 includes the magnetic compass 60-10, the camera 60-13, and the accelerometers 60-4. In another example, the antennas 91-3 are part of the mobile user device 120.

The mobile user device 120 augments the capabilities of the processing subsystem 93. By attaching the mobile user devices 120 to the UAVs 102 via the USB connection, the UAVs 102 can execute the various learning operations (and be updated with new learning) without having to modify any software or hardware already present at the UAV 102. Moreover, the low cost commodity nature of the user device allows for the provision of these features while limiting component costs.

FIG. 3B shows components of the mobile user device 120 in FIG. 3A. Here, substantially the same components that are included in the processing subsystem 93 in FIG. 2B are instead included and executed within the mobile user device 120. These components include the local software 89, the operating system 84, the central processing unit 82, the signal processor 10, the network interface 41, the sensor subsystem interface 49, the inertial measurement system (IMS) 11, the flight controller 8, and the memory 88.

The mobile user devices 102 are continuously updated with more powerful processing cores, support many different peer-to-peer wireless protocols, and are designed to work in nearly any wireless communication framework (e.g. GSM, LTE, or CDMA). In another example, the devices 120 can execute sophisticated applications such as AI applications and applications that support differential updates. As a result, it is often more cost effective and faster to replace the USB based mobile user devices 102 on each UAV 102 than to upgrade software/firmware/hardware of the UAVs to accomplish the same objective.

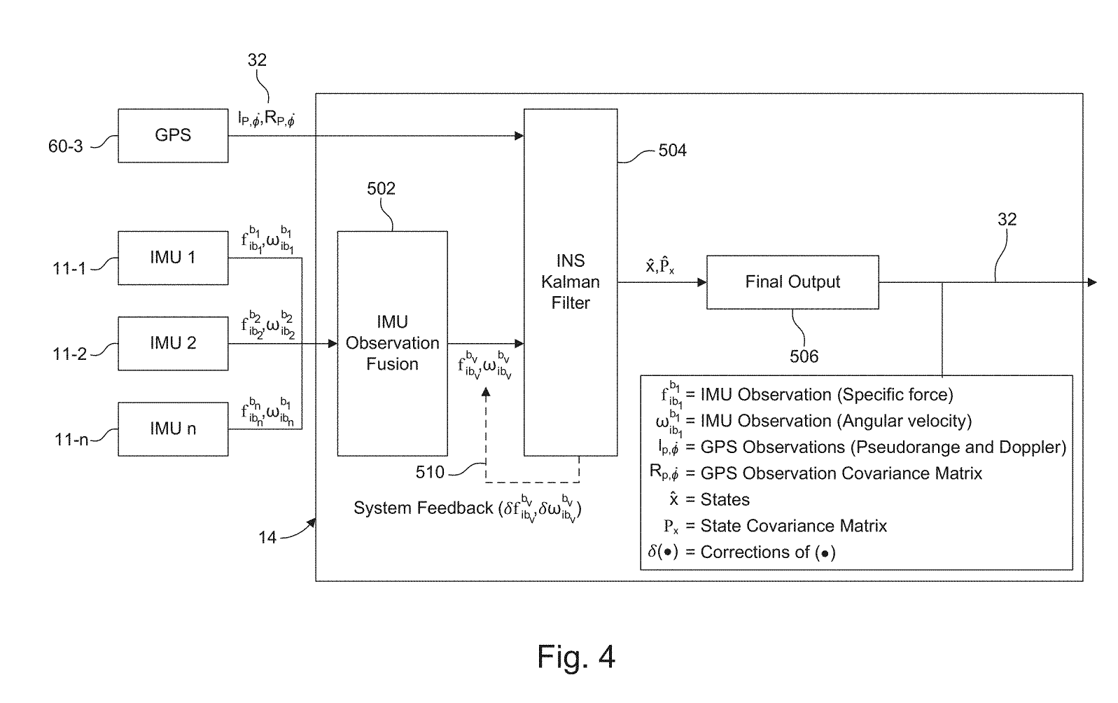

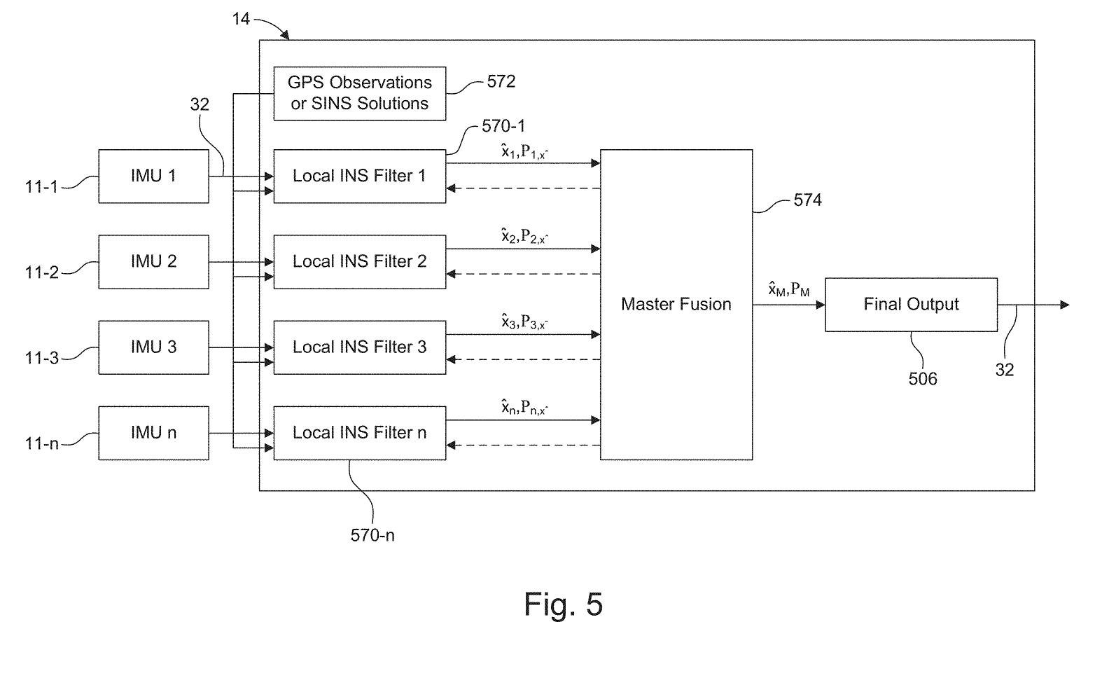

FIG. 4 and FIG. 5 are block diagrams that illustrate different operational models for the AI applications 14. The models in these figures combine the sensor data 32 from the sensors 60 of the UAVs 102 and information from the IMU 11 in different ways. The AI application 14 then sends the fused sensor data 32 for analysis by the PCA system 100.

All signals/sensor data sent to the AI application 14 are first pre-processed by the preprocessing module 10.

FIG. 4 shows a first fusion model of the AI application 14. Here, the sensor data 32 from multiple IMUs/sensors 60-1 through 60-N are first combined/fused, and then formatted. Here, the sensor data 32 is fused into a collection of statistical signals/weights that represent the “raw signals” of the sensor data. Typical fusion algorithms/methods are shown in the figure.

In the illustrated example, several types of filters can be used and at several locations in the case of sensor fusion. The filters include Kalman filter, extended Kalman filter, an unscented Kalman filter, in examples. Based on the sensor data 32 from the sensors 60 being fused, the local software 89 tries several approaches in parallel with the command and control software 142. The command and control software 142 uses the continuously available HPC resources 80 and then decides on the best method to use.

In more detail, at the AI application 14, an IMU Observation Fusion module 502 receives sensor data 32 from the multiple sensors 60-1 . . . 60-N. The fusion module 502 provides the combined sensor data 32 to an INS Kalman filter module 504.

The Kalman filter module 504 also accepts sensor data 32 from the GPS sensor 60. The filter module 504 also has a system feedback loop 510.

The Kalman filter module 504 has the following inputs. The inputs include the sensor data 32 from the GPS sensor 60, the feedback loop 510, and the combined sensor data 32 from the fusion module 302.

The Kalman filter module 504 filters its input to provide filtered sensor data 20 as its output. This filtered sensor data is sent to a final output buffer 506. The AI application 14 can then transmit the filtered sensor data 20 from its final output buffer 506 over a communications network (e.g. cellular) for further analysis by the PCA system 100.

The “fused” version of the sensor data 32 at the final output stage 506 includes statistical versions of the sensor data 32. These statistical versions include: GPS signals, accelerometer signals, and gyroscope signals, in examples. In other examples, the signals can be from the following devices or sensors: a Geiger counter/dosimeter, a chemical or bio detector; the sonar sensor 60-20, and the radar/LIDAR sensor 60-19.

FIG. 5 shows how the AI application 14 can alternatively pre-process the sensor data 32 from each sensor and then fuse the data. The sensor data 32 from each sensor 60 includes inertial measurement systems (IMUs).

In more detail, sensors 60-1 . . . 60-N on user device 20 send their sensor data 32 for pre-processing by the AI application 14. At the AI application 14, separate local INS filter modules 570-1 . . . 570-N for each sensor 60-1 . . . 60-N receive the sensor data 32 from each sensor 60. A GPS observations/SINS Solutions module 572 also provides input to each of the local INS filter modules 570.

Alternatively, rather than fusing the sensor data 32 locally at each user device 20, the sensor data 32 can be sent to the command and control module 142 of the global software 79. At the controller 44, the command and control module 142 uses the sensor data 32 sent by one or more user devices 20 in conjunction with additional simulations and training, and sends a trained model 70 for use at the UAVs in response.

The local INS filter modules 570 then provide filtered versions of the combined sensor data 32/GPS observations as input to a master fusion module 574. The master fusion module 574 combines its input to produce a fused and filtered version of the sensor data 32. This sensor data 32 is then sent to final output buffer 506.

Multiple sensors 60 in different and dynamic changing configurations can now be used. These configurations are limited only by computation, power, weight and design considerations.

The system 200 can use any external sensors if needed. These sensors 60 may be accessible by the USB interface of the processing subsystem 93 or by Bluetooth or other network protocols. The additional sensors 60 could be used to add functionality or to increase the accuracy of the existing sensors 60, such as the accelerometers 60-4, the gyroscopes 60-5, and the compass 60-10.

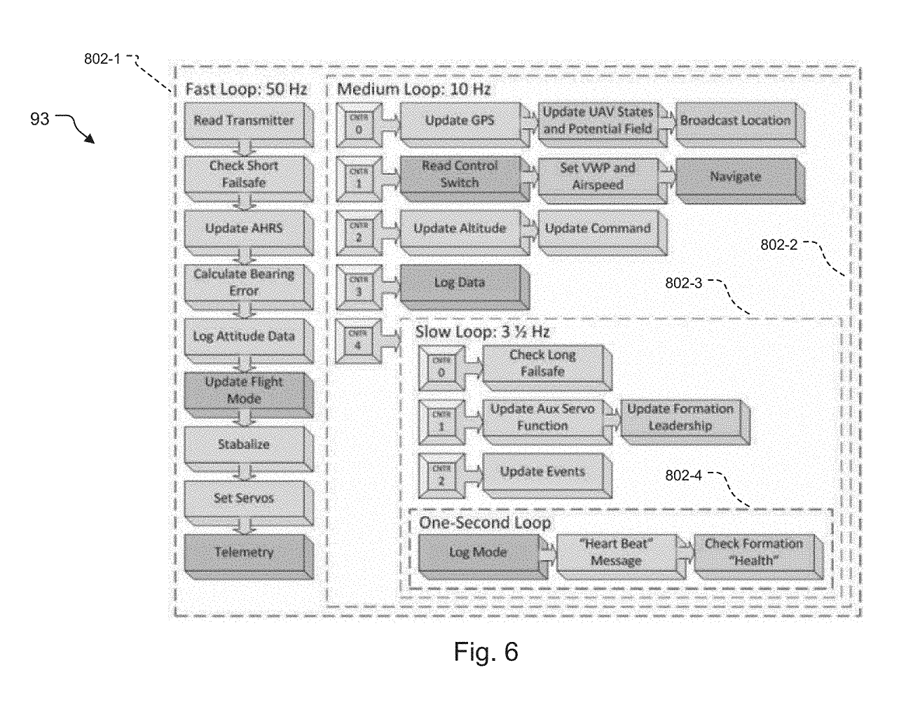

FIG. 6 shows different flight-related control loops executed by the processing subsystem 93 of the UAV 102. Four different control loops 802-1, 802-2, 802-3, and 802-4 are shown.

In more detail, fast control loop 802-1 includes tasks that the processor subsystem 93 executes over a 50 Hertz (Hz) cycle. Medium control loop 802-2 includes tasks that execute in a 10 Hz cycle. Slow control loop 802-3 includes tasks that execute in a 3.5 Hz cycle. One-second loop 802-4 includes tasks that execute in one second.

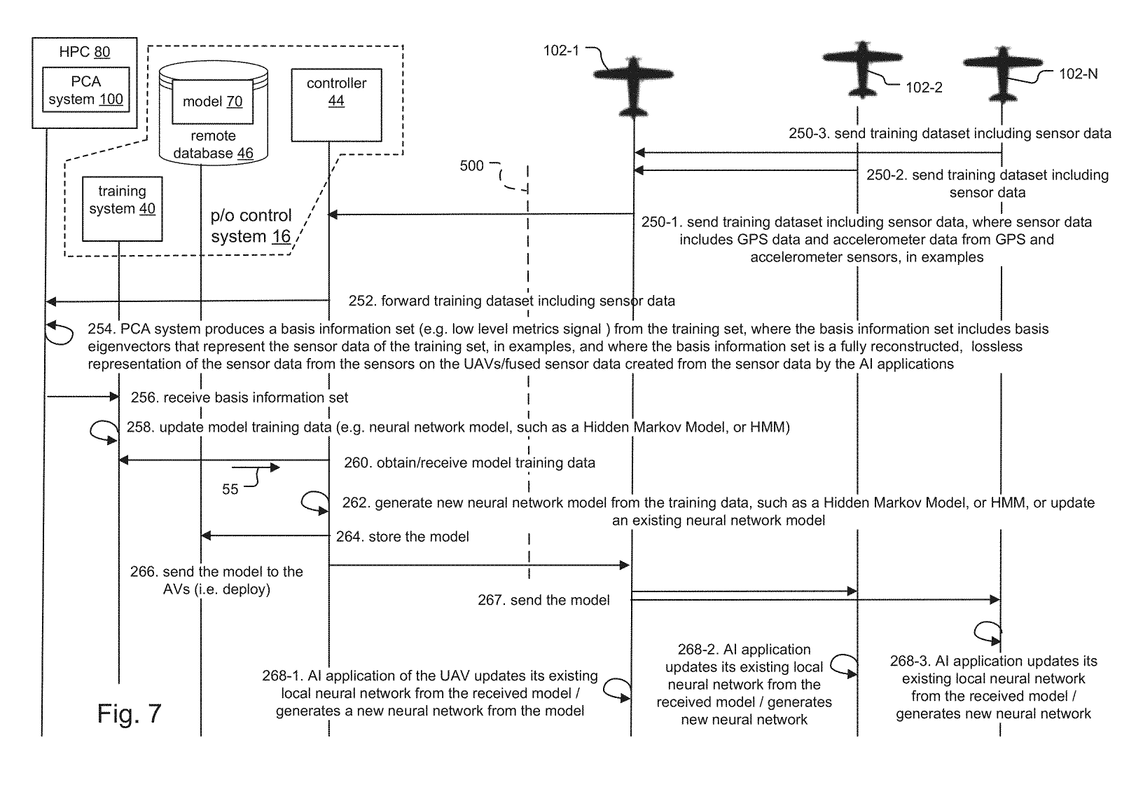

FIG. 7 shows interactions between UAVs and various components of the vehicular system 200.

In step 250-1, 250-2, and 250-3, UAVs 102-1, 102-2, and 102-N each create training datasets 28 based on sensor data 32-1, 32-2, and 32-N. The UAVs send the training datasets to the local controller UAV 102-1, which then sends those training sets to the controller 44 over a wireless connection to the controller 44.

Preferably, the local controller UAV combines its sensor data with the sensor data from the other UAVs in the swarm, and sends a single training dataset 28 that includes the combined sensor data 32.

In step 252, the controller 44 forwards the training dataset(s) 28 to the High Performance Computing System (HPS) 80. According to step 254, the PCA system 100 of the HPC 80 produces a basis information set (e.g. low level metrics signal 140) from the training sets 28. The basis information set/low level metric signals 140 include basis eigenvectors that represent the sensor data 32 of the training sets 28, in examples. The basis information set/signals 140 is a fully reconstructed, lossless representation of the sensor data from the sensors on the UAVs/fused sensor data created from the sensor data 32 by the AI applications 14.

In step 256, the training system 140 receives the basis set/signals 140 from the training system 40, and updates the model training data 55 in response at step 258. In examples, the training data 55 trains a neural network model, such as a Hidden Markov Model, or HIVIM. Other neural network models include recurrent neural networks (RNNs) with long short-term memory (LSTM), hybrid RNN/LSTMs with convolutional neural networks (CNNs, or ConvNets) (particularly if processing image data) and GANs.

According to step 260, the controller 44 receives the model training data 55 sent from the training system 40. Then, in step 262, the controller 44 generates a new network model 70 from the training data 55, or updates an existing network model 70 from the training data 55. The controller 44 stores the network model 70 to the remote database 46 in step 264.

In step 266, the controller 44 sends the model 70 to the UAVs over the differential update system 500 to deploy the model on the UAVs. When the UAVs 102 are members of a swarm 702, for example, the controller 44 sends the model 70 to the local controller UAV 102-1 for the swam. The local controller UAV 102-1 then deploys the model 70 to the other UAVs in the swarm 702, as indicated in step 267.

Then, in steps 268-1, 268-2, and 268-N, the AI applications 14 of the UAVs 102-1, 102-2, 102-N update their existing local neural networks 99 from the received model 70 or generate a new neural network from the model 70. Each UAV 102 might deploy a different neural network 99 for different specialized purposes.

Based on the sensors on the UAVs, one or more neural networks 99 on each UAV learns/encapsulates various information. This information includes: sensor signals characteristics for each sensor 60, including sensor fusion and PCA decomposition; position and timing characteristics for a given formation/group of UAVs in a given wind pattern; optimal ways to reform swarms 702, and related communications QoS levels and topology; a best way to minimize, within a swarm, relative positions in a given wind pattern; a best way to use available power and storage resources; and a best sensor fusion algorithm to use for a particular sensor type, in examples. As a result, in one example, the data from the sensors 60 is processed on the UAVs using sensor fusion and PCA decomposition.

The information might also include the best neural network architecture, which the AI application 14 dynamically selects. During the selection, the AI application 14 chooses from several types of Neural Network (NN) Architectures, including dynamic RNN's with LSTM's, CNN's and GAN's as well as more traditional architectures like standard backpropagation networks with many hidden layers (deep) during learning for each sensor or other parameter or metric.

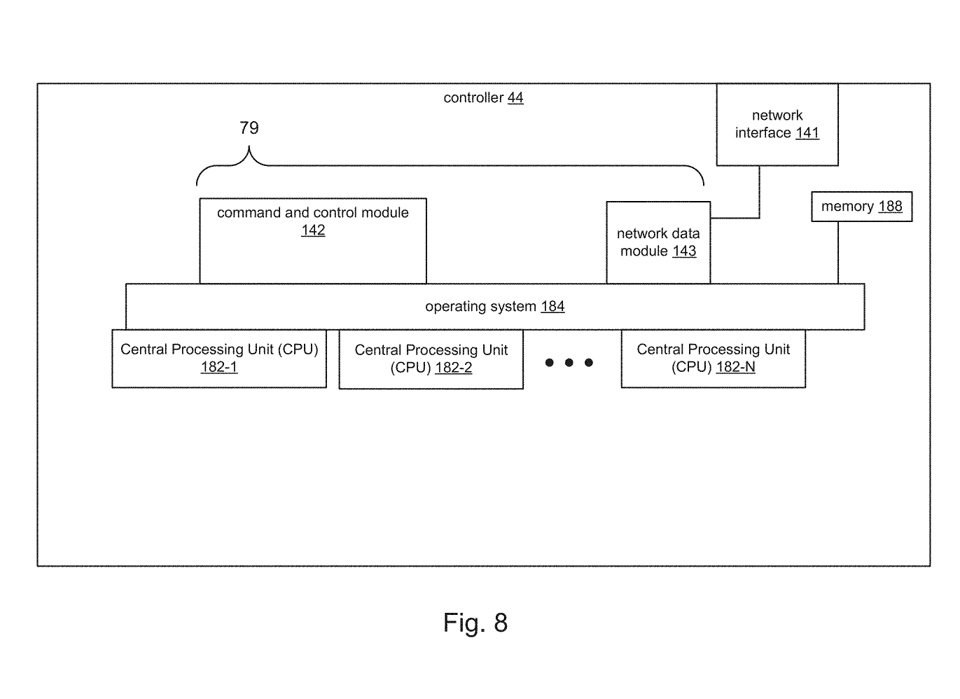

FIG. 8 shows more detail for the controller 44. Specifically, the figure shows detail for global software 79 and components that enable execution of the global software 79 on the controller 44.

In the illustrated example, the controller 44 includes the operating system 184, the global software 79, memory 188, a network interface 141, and one or more computer processing units (CPUs) 182-1 . . . 182-N. The operating system might be Windows or Linux-based, in examples. The CPUs 182 may include multiple independent cores, may support multithreading, and might be graphics processing units or special purpose processing units, in examples.

The global software 79 includes an AI module 144, a command and control module 142 and a network data module 143.

The operating system 184 loads the global software 79 into the memory 188 and schedules the global software 79 for execution by the CPU(s) 182.

The controller 44 can access networks via the network data module 143 and the network interface 141. The network data module 143 receives information from one or more network connections via the network interface 141, and sends information to the network interface 141 for transmission over the one or more network connections.

In one implementation, the command and control module 142 and the network data module 143 implement the controller portion of the differential update system 500. The controller portion of the differential update system 500 operates in a substantially similar fashion as the UAV portion(s) of the system 500 at each of the UAVs to accomplish differential updates of information between the controller 44 and the UAVs 102.

Other tasks performed by command and control module 142 include: communication protocol (TCP/IP) simulation, providing real world interfaces, event simulations, designing scenario files, transferring knowledge and event information from some UAVs to other UAVs, and simulating operation of the UAVs.

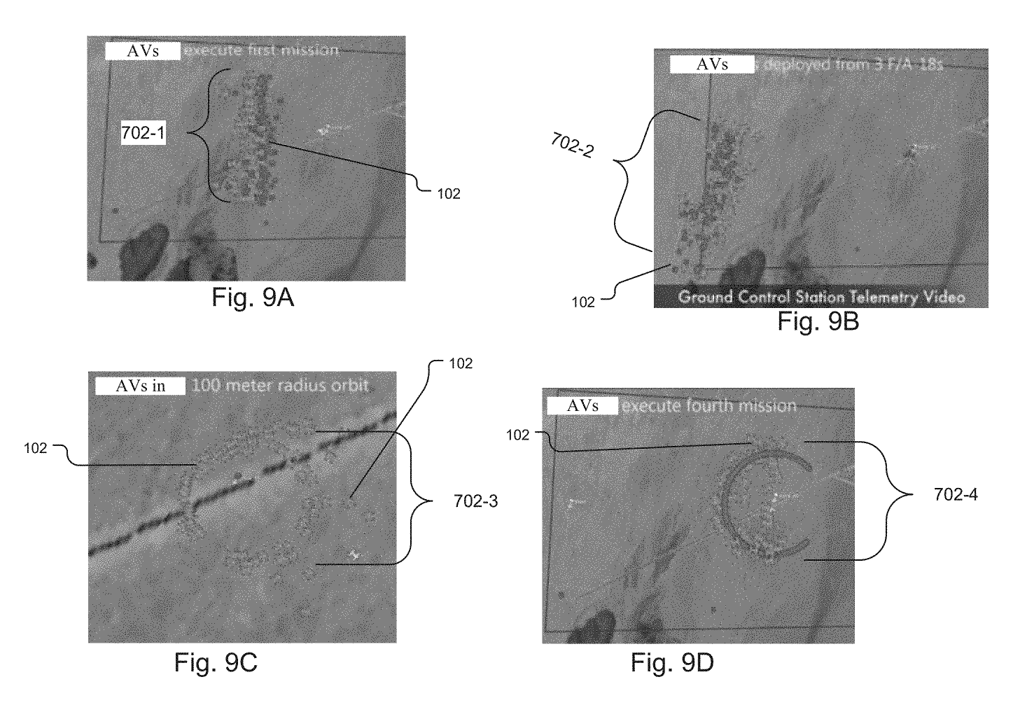

FIG. 9A-9D show simulations performed on the HPC for different missions of UAVs executed by the system 200. The UAVs in each mission are formed into cooperative swarms 702 of the UAVs by the distributed control system 16 and/or by the UAVs themselves. Possibly hundreds of UAVs 102 within the swarms 702 each of the figures are shown.

In FIG. 9A, the UAVs 102 are included within swarm 702-1. The UAVs in the swarm 702-1 are arranged substantially in a straight line. In FIG. 9B, the UAVs in swarm 702-2 are also arranged in substantially in a straight line, and are shown moving at substantially the same direction at the same time. In FIG. 9C, the UAVs 102 form into a near circular formation within swarm 702-3. In FIG. 9D, the UAVs in swarm 702-4 are in a formation that resembles the letter “C”.

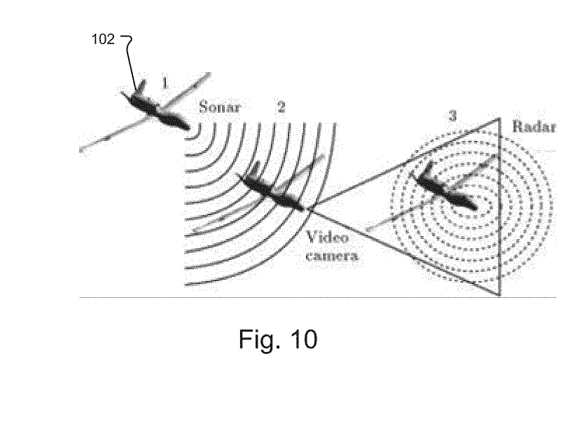

FIG. 10 is a schematic of sonar, radar and video capabilities of a typical UAV. The UAVs use data from sensors including sonar sensors 60-20, radar/lidar sensors 60-19, and camera sensors 60-13.

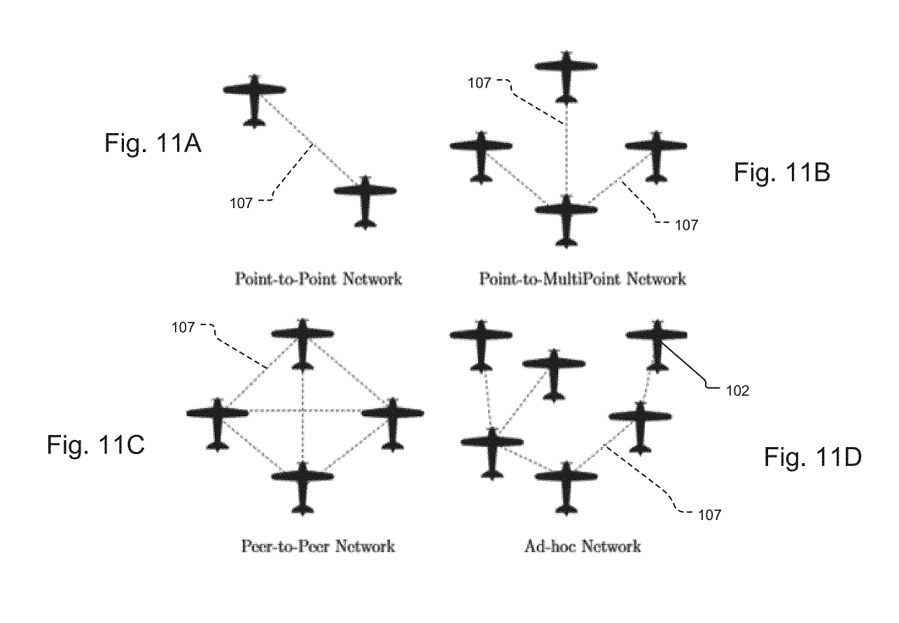

FIG. 11A-11D show different networks of UAVs. The UAVs form the networks from the data connections 107 that the UAVs dynamically create between each other. The UAVs make the data connections 107 using wireless protocols such as WiFi and Bluetooth, in examples.

FIG. 11A shows a point to point network of two UAVs. In this example, each UAV is connected to only one other UAV 102.

FIG. 11B shows a point-to-multipoint network of three UAVs. Here, one of the UAVs connects to all other UAVs, and the other UAVs do not connect with each other.

FIG. 11C shows a peer-to-peer network of four UAVs. In this example, each UAV is connected to each other UAV.

FIG. 11D shows an ad-hoc network of four UAVs. In this example, each UAV might be connected to one or more UAVs.

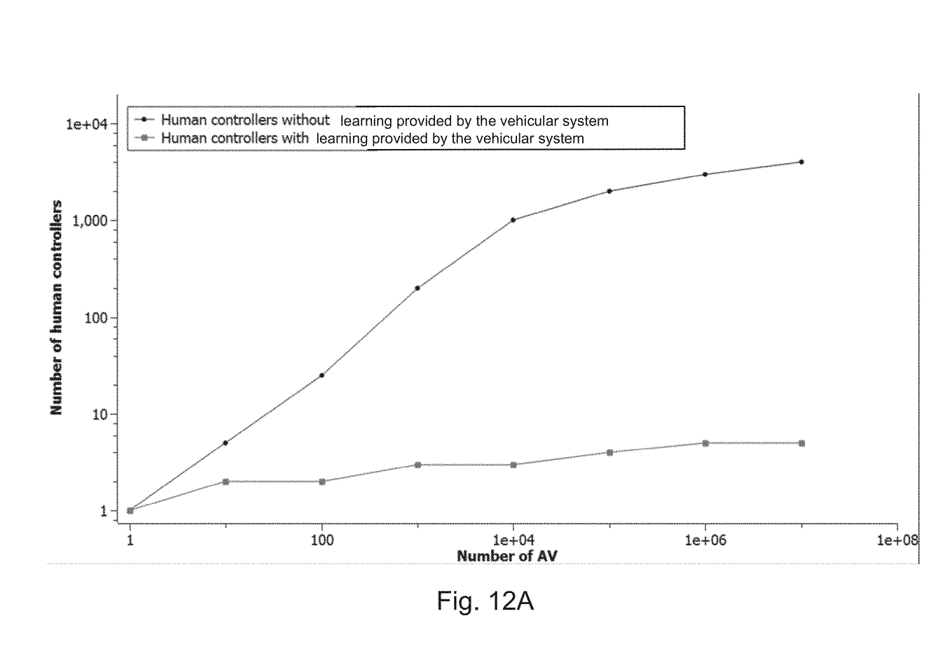

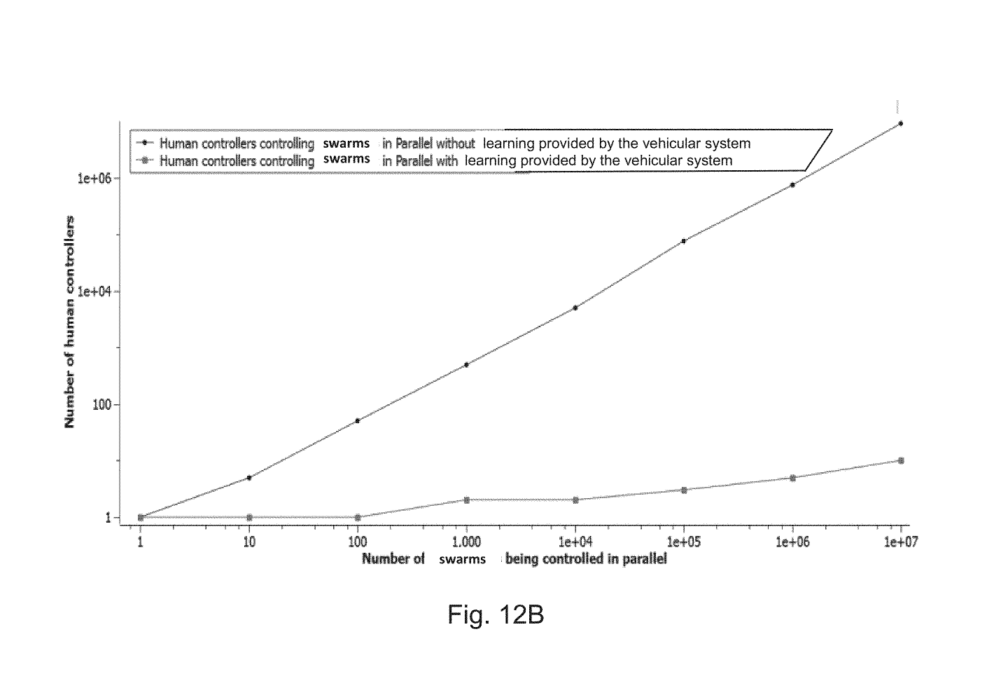

FIG. 12A shows two logarithmic scale plots that display an estimated number of humans required to control an individual swarm of UAVs, as a function of the number of UAVs in the swarm.

A first plot shows the result when the UAVs in the swarm are not controlled with the vehicular system 200. Here, the number of human operators required has a near linear/1:1 relationship to the number of UAVs, up to approximately 1000 UAVs. After 1000 UAVs, the plot decreases its slope, but the number of human controllers still increases with an increasing number of UAVs 102. As a result, the figure shows that it is virtually impossible for a cooperative swarm including typically 100 or more UAVs to be humanly controlled.

A second plot shows the result when the learning and active adaptation and control provided by the vehicular system 200 are employed. The plot is virtually flat, from one UAV in the group up to thousands of UAVs in the group. For example, the second plot estimates that fewer than five human operators/controllers are required to operate the vehicular system 200 when possibly one million or more UAVs are in a swarm/group and under control by the system 200.

FIG. 12B shows two logarithmic scale plots that display an estimated number of humans required to control multiple swarms of UAVs in parallel, as a function of the number of swarms of the UAVs.

The first plot shows the result when the multiple swarms are not controlled with the vehicular system. The number of swarms and the number human controllers required to control the swarms tracks nearly 1:1 for any number of swarms. As a result, the figure shows that it is virtually impossible for more than 100 swarms to be humanly controlled.

The second plot shows the result when the learning and active adaptation and control provided by the vehicular system are employed to control multiple swarms in parallel. The plot is virtually flat, from one swarm up to thousands of swarms, or more. For example, the second plot estimates that fewer than five human operators/controllers are required to operate the vehicular system 200 when possibly one million or more groups of UAVs controlled in parallel by the system 200.

While this invention has been particularly shown and described with references to preferred embodiments thereof, it will be understood by those skilled in the art that various changes in form and details may be made therein without departing from the scope of the invention encompassed by the appended claims.

What is claimed is:

1. A vehicular system, comprising:
a group of vehicles that communicate directly with each other; and
a distributed control system that controls and manages the group.

2. A system as claimed in claim 1, wherein the vehicles are unmanned aerial vehicles.

3. A system as claimed in claim 1, wherein the group includes greater than 100 vehicles.

4. A system as claimed in claim 1, wherein the group includes greater than 1000 vehicles.

5. A system as claimed in claim 1, wherein one or more of the vehicles of the group is designated as a group local controller.

6. A system as claimed in claim 1, wherein the vehicles employ autonomous learning to form the group.

7. A system as claimed in claim 1, wherein the distributed control system controls and manages a size and formation of the group.

8. A system as claimed in claim 1, wherein the distributed control system includes a training system and a controller.

9. A system as claimed in claim 1, wherein the distributed control system specifies destinations and time to reach those destinations for the group and the group determines self-avoiding trajectories to reach the destinations.

10. A system as claimed in claim 1, further comprising a differential update system for updating operation of the vehicles.

11. A system as claimed in claim 1, wherein the vehicles communicate directly with each other using WiFi and/or Bluetooth protocols.

12. A system as claimed in claim 1, wherein the group of vehicles controls its division into subgroups of the vehicles.

13. A system as claimed in claim 1, wherein each of the vehicles includes sensors for gathering data.

14. A system as claimed in claim 13, wherein the data from the sensors is processed on the vehicles using sensor fusion and PCA decomposition.

15. A system as claimed in claim 13, wherein the data from the sensors is used to determine position and timing characteristics for the group for a detected wind pattern based on the sensors.

16. A system as claimed in claim 1, wherein the sensors include one or more accelerometers, gyroscopes, pressure sensors, gravimeter, and/or electro-magnetometers.

17. A system as claimed in claim 1, wherein the distributed control system sends initial models with background simulation data to each vehicle, the initial models providing each of the vehicles with autonomous control and group formation capabilities.

18. A system as claimed in claim 1, wherein each of the vehicles learn separately, which learning is sent to a local controller of the group, which is then sent to the distributed control system, which generates new models to the vehicles.

19. A vehicular control method, comprising:
a group of vehicles communicating directly with each other; and
a distributed control system of the group controlling and managing the group.

20. A vehicular system, comprising:
a group of vehicles that communicate directly with each other and the executing neural networks and train the networks; and
a control system that controls and manages the group.
